(19) United States
(12) Patent Application Publication
(10) Pub. No.: US 2006/0195699 A1
(43) Pub. Date: Aug. 31, 2006

(54) Power saving and system security method for computer system

(76) Inventors: Shun-Yung Liao, Kuei Shan Hsiang (TW); Chun-Yi Lu, Kuei Shan Hsiang (TW)

Correspondence Address: RABIN & BERDO, P.C., Suite 500, 1101 14 Street, N.W., Washington, DC, 20005, US

(21) Appl. No.: 11/152,058

(22) Filed: Jun. 15, 2005

(30) Foreign Application Priority Data
Feb. 16, 2005 (TW) 94104545

(51) Int. Cl. H04L 9/00; G06F 12/14; H04L 9/32; G08B 13/18; G08B 13/14

(52) U.S. Cl. 713/183; 726/17; 726/27; 340/567; 340/568.1

(57) ABSTRACT

A power saving and system security method for a computer system is described. A PIR (personal infrared) sensor is launched. Presence of a human body is detected by using PIR sensor and sending to a signal to a processor. When the processor decides nobody is in an effective area of the PIR sensor, a power saving and system security function is executed. The presence of a human body is continuously searched for by using the PIR sensor and sending a signal to the processor. When somebody is in the effective area of the PIR sensor, the power saving and system security function is exited by inputting a correct password.

### RELATED APPLICATIONS

The present application is based on, and claims priority from, Taiwan Application Serial Number 94104545, filed Feb. 16, 2005, the disclosure of which is hereby incorporated by reference herein in its entirety.

### BACKGROUND

1. Field of Invention

The present invention relates to a power saving and system security method. More particularly, the present invention relates to a power saving and system security method for a computer system.

2. Description of Related Art

A personal computer has become essential equipment in a modern office. A majority of personal computers in the modern office consume a lot power, which is expensive. Personal computers are employed to process lots of document data; many trade secrets are thus put or generated in the computer system. Therefore, power saving and system security functions have get involved to reduce power costs and to protect information therein.

Conventional computer systems may be programmed into a power saving mode, such as a screen shutdown function, a hard disk shutdown function, a system sleep function, or a system standby function, after a system idle time. However, the above functions are executed at a predetermined time after a user does not operate the computer system. A computer may frequently be programmed into a power saving mode, but the user still sits in front of it. On the contrary, a computer is not programmed into a power saving mode, while the user may have left for a long time already. Because the predetermined time is due, the computer will be programmed into a power saving mode automatically.

Similar circumstances occur in system security programs, such as a screen protection program.

Thus, a power saving and system security method, executed by presetting-time, causes inconvenience to a user.

### SUMMARY

It is therefore an objective of the present invention to provide a power saving and system security method using a PIR sensor.

In accordance with the foregoing and other objectives of the present invention, a power saving and system security method for a computer system is provided. A PIR (personal infrared) sensor is launched. A human body is detected by the PIR sensor and a signal is sent to a processor. When the processor decides nobody is in an effective area of the PIR sensor, a power saving and system security function is executed. Continuous detection of a human body is performed by the PIR sensor and a signal is sent to the processor. When somebody is in the effective area of the PIR sensor, the power saving and system security function is exited by inputting a correct password.

Thus, the power saving and system security method using a PIR sensor not only achieves the goal of saving power and locking the screen while no one is in front of a computer, but also overcomes inconveniences of saving power and locking the screen, executed by time setting.

It is to be understood that both the foregoing general description and the following detailed description are examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention, and, together with the description, serve to explain the principles of the invention. In the drawings,

FIG. 1 illustrates how a computer, equipped with a PIR sensor, detect a human body according to one preferred embodiment of this invention; and

FIG. 2 illustrates a flowchart of a power saving and system security method according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to overcome the shortcomings of conventional power saving and system security function, the present invention provides a power saving and system security method using a PIR (personal infrared) sensor.

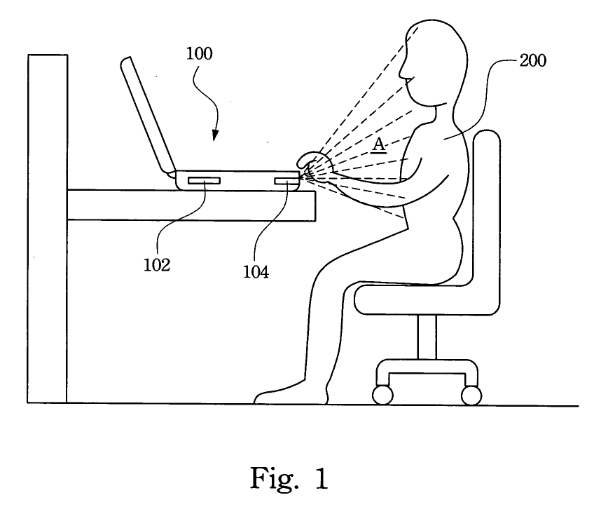

FIG. 1 illustrates how a computer, equipped with a PIR sensor, detects a human body according to one preferred embodiment of this invention. A computer 100, which is equipped with a PIR sensor 104, has a function for detecting the user 200. The PIR sensor 104 is a sensor, which can detect an infrared radiation of human body's heat. It is applied in an illumination field, such as an illumination device with an automatic on/off switch function. The PIR sensor 104 can detect a signal, emitted from a human body, and send the signal to a processor 102 of a computer 100, whereby the computer 100 judges whether the human body is in an effective area A of the PIR sensor 104, or not. The effective area A is defined an area between the user 200 and the computer 100 when the user 200 is operating front of the computer 100.

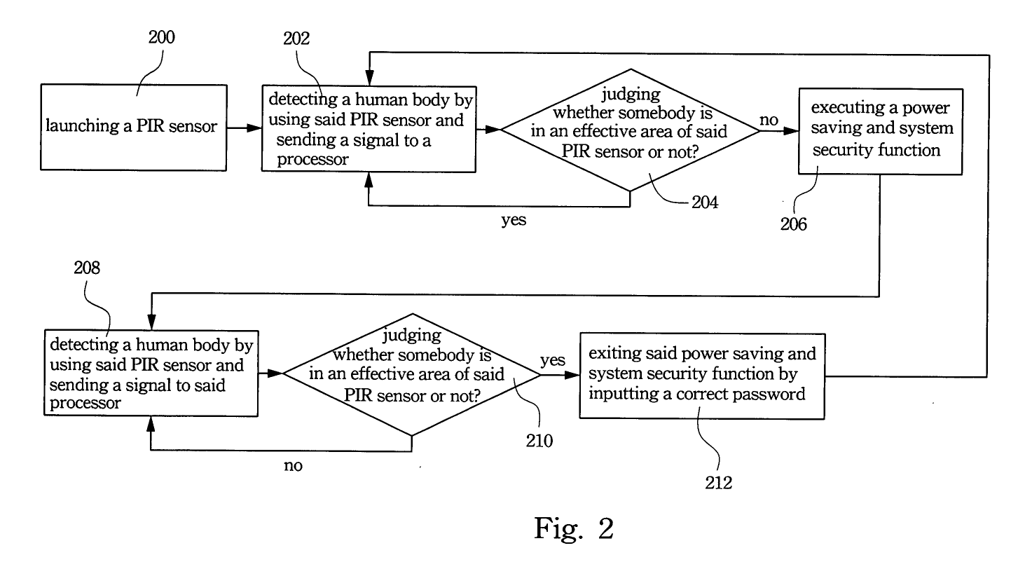

FIG. 2 illustrates a flowchart of a power saving and system security method according to one preferred embodiment of this invention. This method is suitable for any computer system equipped with a PIR sensor. In Step 200, a PIR sensor 104 is launched by a user or when a computer system is turned on. In Step 202, a human body is detected by using the PIR sensor and sending a signal to a processor of the computer system for judging. In Step 204, the processor decides whether somebody is in an effective area of the PIR sensor (judging the signal transmitted from the PIR sensor) or not. When the processor decides that somebody is in the effective area of the PIR sensor, step 202 is executed again. When the processor decides that nobody is in the effective area of the PIR sensor, step 206, a power saving and system security function, is executed. The power saving function can be a screen shutdown function, a hard disk shutdown function, a system standby function or a system sleep function. The system security function can be a screen protection program or other similar program. In Step 208, the human body is continuously detected by using the PIR sensor and sending a signal to the processor of the computer system for judging. In Step 210, the processor decides whether somebody is in an effective area of the PIR sensor (judging the signal transmitted from the PIR sensor) or not. When the processor decides nobody is in the effective area of the PIR sensor, step 208 is executed again. When the processor decides somebody is in the effective area of the PIR sensor, step 212, exiting the power saving and system security function by inputting a correct password, is executed. After step 212, step 202 is executed again.

According to preferred embodiments, the power saving and system security method using a PIR sensor not only achieves the goal of saving power and locking the screen when nobody is sitting in front of a computer, but also overcomes inconveniences of saving power and locking the screen, executed by time setting.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A power saving and system security method for a computer system, said system including a processor, said power saving and system security method comprising the steps of:
(a) launching a personal infrared (PIR) sensor disposed in said computer and electric connecting said processor;
(b) detecting a human body by using said PIR sensor and sending a signal to said processor from said PIR sensor;
(c) executing a power saving and system security function when said processor decides nobody is in an effective area of said PIR sensor;
(d) continuously searching for a human body in said effective area by using said PIR sensor and sending a signal to said processor; and
(e) exiting said power saving and system security function by inputting a correct password when somebody is in said effective area of said PIR sensor.

2. The power saving and system security method of claim 1, after step (b) further comprising:
not executing a power saving and system security function when said processor decides somebody is in an effective area of said PIR sensor.

3. The power saving and system security method of claim 2, wherein said system security function includes a screen protection program.

4. The power saving and system security method of claim 3, wherein said power saving function includes a screen shutdown function, a hard disk shutdown function, a system sleep function, or a system standby function.

5. The power saving and system security method of claim 1, wherein said system security function includes a screen protection program.

6. The power saving and system security method of claim 1, wherein said power saving function includes a screen shutdown function, a hard disk shutdown function, a system sleep function, or a system standby function.
